(19) United States
(12) Patent Application Publication
(10) Pub. No.: US 2026/0064289 A1
(43) Pub. Date: Mar. 5, 2026

(54) CHARGE LOSS TEMPERATURE COMPENSATION IN A MEMORY SUB-SYSTEM

(71) Applicant: Micron Technology, Inc., Boise, ID (US)

(72) Inventors: Steven Michael Kientz, Westminster, CO (US); Lei Zhang, Bukit Timah (SG)

(21) Appl. No.: 18/819,539

(22) Filed: Aug. 29, 2024

(51) Int. Cl. G06F 3/06

(52) U.S. Cl. CPC G06F 3/0619; G06F 3/0653; G06F 3/0679

(57) ABSTRACT

A system includes a memory device and a processing device operatively coupled with the memory device to perform operations including determining an operating temperature value for the memory device; determining a charge loss adjustment value based on the operating temperature value of the memory device and a reference temperature value for the memory device; determining a charge loss value for a first block of a plurality of blocks of the memory device; obtaining a normalized charge loss value for the first block based on the charge loss value and the charge loss adjustment value; and performing a first memory operation on the first block based on the normalized charge loss value.

### TECHNICAL FIELD

Embodiments of the disclosure relate generally to memory sub-systems, and, more specifically, relate to implementing charge loss temperature compensation in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2 depicts an example graph, illustrating the dependency of charge loss after program (V_{T} offset) on the time after program (i.e., the period of time elapsed since the block has been programmed), according to with some aspects of the disclosure.

FIG. 3 schematically illustrates selecting block families for calibration, according to some aspects of the disclosure.

FIGS. 4A-4B are diagrams of V_{T} distributions illustrating an example implementation of adaptive block family error avoidance (BFEA) in a memory sub-system, according to some aspects of the disclosure.

FIG. 5 illustrates a plot of charge loss against time in a memory device, according to some aspects of the disclosure.

FIG. 6 is a flow diagram of an example method to implement charge loss temperature compensation in a memory sub-system, according to some aspects of the disclosure.

FIG. 7 is a flow diagram of an example method to implement charge loss temperature compensation in a memory sub-system, according to some aspects of the disclosure.

FIG. 8 is a block diagram of an example computer system in which embodiments of the present disclosure may operate.

### DETAILED DESCRIPTION

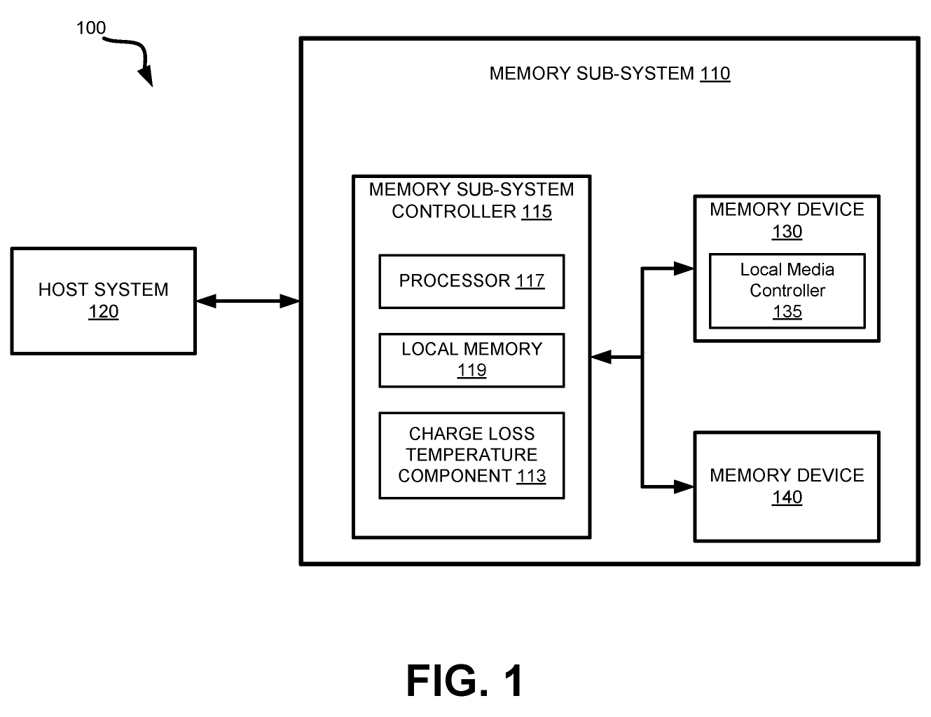

Aspects of the present disclosure are directed to implementing charge loss temperature compensation in a memory sub-system. A memory sub-system can be a storage device, a memory module, or a combination of a storage device and a memory module. Examples of storage devices and memory modules are described below in conjunction with FIGS. 1A-1B. In general, a host system can utilize a memory sub-system that includes one or more components, such as memory devices that store data. The host system can provide data to be stored at the memory sub-system and can request data to be retrieved from the memory sub-system.

A memory sub-system can include high-density non-volatile memory devices where retention of data is desired when no power is supplied to the memory device. One example of a non-volatile memory device is a negative-AND (NAND) memory device. Other examples of non-volatile memory devices are described below in conjunction with FIGS. 1A-1B. A non-volatile memory device is a package of one or more dies. Each die includes one or more planes. For some types of non-volatile memory devices (e.g., NAND devices), each plane includes a set of physical blocks. Each block consists of a set of pages. Each page includes a set of memory cells. A memory cell is an electronic circuit that stores information. Depending on the memory cell type, a memory cell can store one or more bits of binary information and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

Some memory devices can be three-dimensional (3D) memory devices (e.g., 3D NAND devices). For example, a 3D memory device can include memory cells that are placed between sets of layers including a pillar (e.g., polysilicon pillar), a tunnel oxide layer, a charge trap (CT) layer, and a dielectric (e.g., oxide) layer. For example, a 3D memory device can be a 3D replacement gate memory device having a replacement gate structure using wordline stacking.

The memory sub-system can perform host-initiated memory access operations. For example, the host system can initiate a data operation (e.g., write, read, erase, etc.) on a memory sub-system. The host system can send access requests (e.g., write command or read command) to the memory sub-system, such as to store data on a memory device at the memory sub-system and to read data from the memory device on the memory sub-system. The data to be read or written, as specified by a host request, is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., ECC codeword, parity code), data version (e.g. used to distinguish age of data written), valid bitmap (which LBAs or logical transfer units contain valid data), etc.

A memory cell (“cell”) can be programmed (e.g., written to) by applying a certain voltage to the cell, which results in an electric charge being held by the cell. For example, a voltage signal V_{CG} can be applied to a control electrode of the cell to open the cell to the flow of electric current across the cell between a source electrode and a drain electrode. More specifically, for each individual cell (having a charge Q stored thereon), there can be a threshold control gate voltage V_{T} (also referred to as the “threshold voltage”) such that the source-drain electric current is low for the control gate voltage (V_{CG}) being below the threshold voltage, V_{CG} < V_{T}. The current increases substantially once the control gate voltage has exceeded the threshold voltage, V_{CG} > V_{T.} Because the actual geometry of the electrodes and gates varies from cell to cell, the threshold voltages can be different even for cells implemented on the same die. The cells can, therefore, be characterized by a distribution P of the threshold voltages, P(Q,V_{T}) =dW/dV_{T}, where dW represents the probability that any given cell has its threshold voltage within the interval [V_{T},V_{T} +dV_{T}] when charge Q is placed on the cell.

A memory device can exhibit threshold voltage distributions P(Q,V_{T}) that are narrow compared with the working range of control voltages tolerated by the cells of the device. Accordingly, multiple non-overlapping distributions P(Qₖ,V_{T}) (“valleys”) can be fit into the working range, allowing for storage and reliable detection of multiple values of the charge Qₖ, k=1, 2, 3… The distributions (valleys) are interspersed with voltage intervals (“valley margins”) where none (or very few) of the cells of the device have their threshold voltages. Such valley margins can, therefore, be used to separate various charge states Qₖ. The logical state of the cell can be determined by detecting, during a read operation, between which two valley margins the respective threshold voltage V_{T} of the cell resides. Specifically, the read operation can be performed by comparing the measured threshold voltage V_{T} exhibited by the memory cell to one or more reference voltage levels corresponding to known valley margins (e.g., centers of the margins) of the memory device.

One type of cell is a single level cell (SLC), which stores 1 bit per cell and defines 2 logical states (“states”) (“1” or “L0” and “0” or “L1”), each corresponding to a respective V_{T} level. For example, the “1” state can be an erased state (L0), and the “0” state can be a programmed state (L1). Another type of cell is a multi-level cell (MLC), which stores 2 bits per cell and defines 4 states (“11” or “L0”, “10” or “L1”, “01” or “L2” and “00” or “L3”), each corresponding to a respective V_{T} level. For example, the “11” state can be an erased state, and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”), each corresponding to a respective V_{T} level. For example, the “111” state can be an erased state, and each of the other states can be a respective programmed state. Another type of a cell is a quad-level cell (QLC), which stores 4 bits per cell and defines 16 states L0-L15, where L0 corresponds to “1111” and L15 corresponds to “0000”. Another type of cell is a penta-level cell (PLC), which stores 5 bits per cell and defines 32 states. Other types of cells are also contemplated. A memory device can include one or more arrays of memory cells such as SLCs, MLCs, TLCs, QLCs, PLCs, etc., or any combination of such. For example, a memory device can include an SLC portion, an MLC portion, a TLC portion, a QLC portion, or a PLC portion of cells.

A valley margin can also be referred to as a read window. For example, in an SLC cell, there is 1 read window that exists with respect to the 2 V_{T} distributions. As another example, in an MLC cell, there are 3 read windows that exist with respect to the 4 V_{T} distributions. As yet another example, in a TLC cell, there are 7 read windows that exist with respect to the 8 V_{T} distributions. Read window size generally decreases as the number of states increases. For example, the 1 read window for the SLC cell may be larger than each of the 3 read windows for the MLC cell, and each of the 3 read windows for the MLC cell may be larger than each of the 7 read windows for the TLC cell, etc. Read window budget (RWB) refers to the cumulative value of the read windows.

As data is repeatedly written and erased in a memory device, such as a flash memory, the memory device may be more susceptible to errors due to various types of noise and disturb mechanisms inherent within the memory cell, which may be exacerbated with repeated programming. As a result, the raw bit error rates (RBERs) for the memory device can increase over time. Given this pattern, the end-of-life RBERs for these devices are much higher as compared to the beginning-of-life RBERs for the respective devices.

To address read errors, a memory sub-system can use an error handling technique to correct errors and verify that the data written into the memory device is the same as the data being read from the respective memory device. In some embodiments, the error handling technique can include performing one or more read retries using different parameters, such as a change in the threshold voltage offset as compared to the initial threshold voltage offset applied in performing a read operation on a set of memory cells.

One phenomenon observed in memory devices is slow charge loss (SCL), which can occur as a function of elapsed time since programming and/or temperature. SCL (also referred to herein as “charge loss”) can cause a V_{T} distribution shift, in which V_{T} distributions shift towards lower voltage levels. That is, the V_{T} distribution shift can be proportional to the elapsed time from a programming operation to a read operation and/or temperature. The the V_{T} distribution shift changes rapidly at first (e.g., immediately after the memory cell was programmed), and then slows down in an approximately logarithmic linear fashion with respect to the time elapsed since programming. Charge loss and the corresponding V_{T} distribution shift can, over time, lead to increasing bit error rates (e.g., raw bit error rates (RBERs)) that require increasing amounts of error correction to address, and, accordingly, increasing amounts of system resources.

Depending on the system workload and program-erase cycles, the elapsed times since programming may vary across blocks. These variations in the elapsed time since programming can result in varying, non-uniform V_{T} distribution shifts of respective blocks if the programming of blocks is spaced significantly in time. As a result of these non-uniform V_{T} distribution shifts, it can be difficult to predict an optimal threshold voltage offset that needs to be applied to the majority of the blocks across wordlines to address charge loss without compromising performance.

In some implementations, the charge loss can be tracked by implementing the block family error avoidance (BFEA), which involves assigning each block of a memory device to a respective predefined block family. Each block family can define a grouping of blocks having a substantially similar elapsed time since programming (e.g., are programmed at or around the same time). In some implementations, the grouping of blocks in a block family can have a substantially similar programming temperature (e.g., are programmed at or around the same temperature of the memory device). Each block family can be assigned to a respective threshold voltage offset bin (“bin”), where each BFEA bin includes a set of threshold level offsets to be applied to respective programming voltage levels to account for V_{T} distribution shifts over time (and temperature changes) resulting from the slow charge loss. As mentioned above, the amount of charge loss of a block can be a function of the elapsed time from a programming operation and/or temperature. Each BFEA bin can be assigned a respective bin index representing a bin number.

In some implementations, a new block family can be created whenever a specified period of time (e.g., a predetermined duration) has elapsed since the creation of a previous block family– regardless of the number of blocks grouped into the previous block family. In some implementations, a new block family can be created whenever a temperature of the memory device changes by a specified threshold value (e.g., a predetermined change in temperature), regardless of the number of blocks in a previous block family (e.g., the block family prior to the creation of the new block family due to the change in temperature).

When a block is first programmed at time 0, the block can be initially assigned to the currently open block family, where the currently open block family is associated with a first bin (e.g., bin 0). A media scan operation (also referred to herein as a “scan operation”) can be performed on representative blocks of each block family at a particular respective V_{T} level periodically (e.g., hourly, daily, etc.) to determine whether the threshold voltage offset for a block, and thus the BFEA bin assignment, should be updated to better track V_{T} distribution shift over time. For example, if the media scan operation indicates that the threshold voltage offset should be updated to the threshold voltage offset assigned to a second bin (e.g., bin 1), then the block family can be reassigned to the second bin.

As discussed above slow charge loss can be tracked and thus mitigated by implementing BFEA. When a charge loss value associated with a block family exceeds a slow charge loss threshold (e.g., also referred to herein as a “bin exit threshold”) for the bin to which the block family is currently assigned, the memory device can reassign the block family to a new bin. In this way, memory operations can be performed on blocks of a block family using memory operation parameters associated with the currently assigned bin. However, if a block family is not moved when the charge loss value of the block family exceeds the bin’s exit threshold, memory operations performed on blocks of that block family are likely to generate an increased number of errors. Thus, it is crucial that the charge loss value for a particular block family is accurately measured and tracked. In some environments, there may be long durations or changes in temperature between when a first charge loss value is determined for a particular block family and a second charge loss value is determined for the particular block family.

For example, a memory sub-system may be powered-off for a first duration. During the powered-off duration, the charge loss value associated with the block family may shift significantly. When the memory sub-system is powered-on and attempts to determine a new charge loss value for the block family, the new charge loss value may be determined inaccurately due to the significant shift in the charge loss value associated with the block family. This inaccuracy in the new charge loss value may prevent the block family from being reassigned to a proper bin, which as mentioned above, can lead to further errors when performing memory operations on blocks of the misassigned block family.

In another example, the memory sub-system may program blocks in a block family at a first temperature of the memory sub-system, and subsequently attempt to read blocks from the block family at a second temperature. Due to the change in temperature, the charge loss value associated with the block family may have shifted significantly. When the memory sub-system attempts to determine a new charge loss value for the block family at the second temperature, the new charge loss value may thus be determined inaccurately. This inaccuracy in the new charge loss value may prevent the block family from being reassigned to a proper bin, which as mentioned above, can lead to further errors when performing memory operations on blocks of the misassigned block family.

In some implementations, the parameters of the memory operations associated with a particular bin may be adjusted based on a determined or predicted change in charge loss. However, in situations where the determined charge loss is large, or the memory sub-system under-predicts the change in charge loss, the adjustments to the parameters of the memory operations may not completely correct the charge loss experienced by blocks of the particular block family.

Aspects of the present disclosure address the above and other deficiencies by adjusting the determined charge loss for the bin by a set amount, based on a table characterizing voltage adjustments for various operating temperatures of a memory device in comparison to a selected reference temperature for the memory device. During production of the memory device, a reference temperature is set. Charge loss over time for the reference temperature is determined. Then charge loss over time for various operating temperatures above and below the reference temperature as similarly determined. A mapping between the slow charge loss at the reference temperature and each of the various operating temperatures is determined. In some embodiments, the mapping is represented in a table of predetermined values. During operation of the memory device, the operating temperature is determined. The memory sub-system determines a difference between the operating temperature and the reference temperature. Based on the determined difference between the operating temperature and the reference temperature, a charge loss adjustment value is determined. In some embodiments, the charge loss adjustment value is determined from the table of predetermined values. The charge loss adjustment value and the initially determined (e.g., measured charge loss value) are used to determine a normalized charge loss value. The normalized charge loss value can represent a charge loss value for the memory device as if the memory device is at the reference temperature. Memory operations can be performed using the normalized charge loss value, including adjustments to parameters of memory operations (e.g., fine-tuning adjustments by the memory device). In some embodiments, the memory operation can be a BFEA operation, such as a media scan operation to determine the bin to which a particular block family should be assigned. In some embodiments, additional BFEA operations can be performed with the normalized charge loss value.

Advantages of the present disclosure include improved memory device performance and reliability. For example, embodiments described herein can achieve improved performance consistency across SCL conditions. Additionally, embodiments described herein can assign a block family to a bin more accurately based on significant changes in charge loss between media scan operations. This more accurate assignment allows the memory device to use parameters for memory operations performed on blocks of the block family to have a reduced number or errors. Accordingly, embodiments described herein can be implemented to reduce read errors and increase the life of a memory device.

The method can be implemented with any suitable memory device architecture in accordance with the embodiments described herein. In one embodiment, the method can be implemented with a memory device implementing replacement gate NAND (RG NAND) technology. A replacement gate (RG) NAND device is a NAND device that implements a RG architecture rather than a floating gate (FG) architecture. The RG NAND architecture removes cell gaps that are typically found in FG NAND architectures, thereby reducing or eliminating capacitance resulting from those cell gaps. More specifically, the RG NAND architecture corresponds to a single-insulator structure. The RG NAND architecture can enable smaller size, improved read and write latency, and an increase in transfer rate as compared to the FG NAND architecture. Further details regarding implementing adaptive block family error avoidance (BFEA) in a memory sub-system will be described below with reference to FIGS. 1-8.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Pillar, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-AND (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single-level memory cells (SLC), can store one bit per memory cell. Other types of memory cells, such as multi-level memory cells (MLCs), triple-level memory cells (TLCs), quad-level memory cells (QLCs), and penta-level memory cells (PLCs) can store multiple bits per memory cell. In some embodiments, each of the memory devices 130 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application-specific integrated circuit (ASIC), etc.), or another suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control the operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

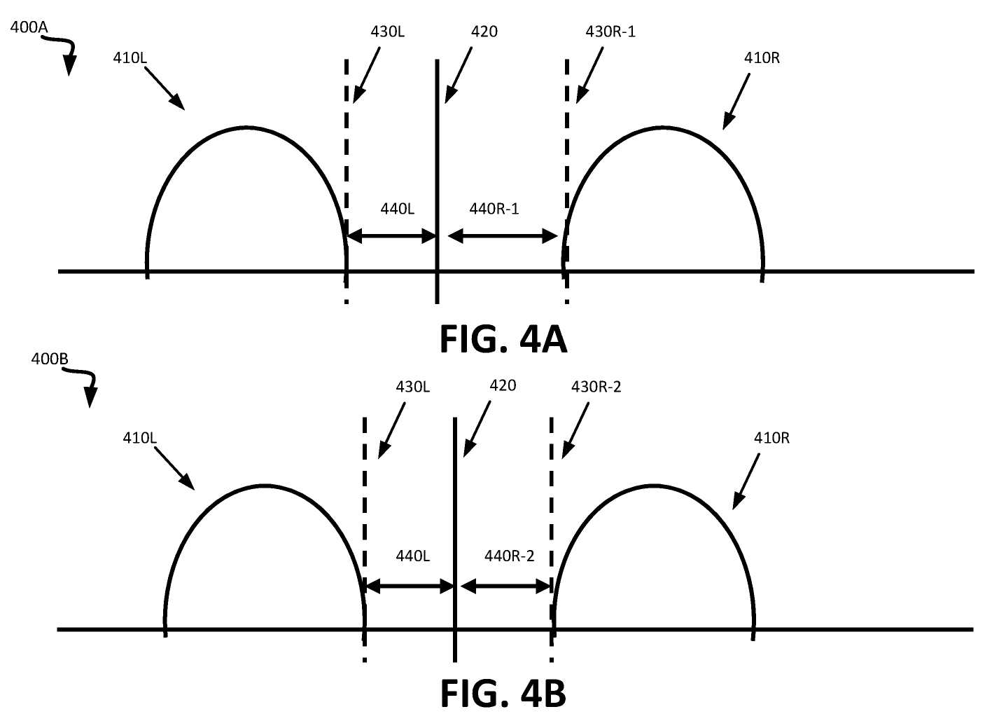

The memory sub-system controller 115 can implement a charge loss temperature component 113. The charge loss temperature component 113 determine a current temperature value of the memory device 130, and a measured charge loss value for a block family of the memory device 130. The charge loss temperature component 113 can use the current temperature value and the measured charge loss value for the block family to generate a normalized charge loss value. In some embodiments, the normalized charge loss value is generated using a predetermined table of characterized values. The predetermined table includes various temperature values associated with a respective charge loss adjustment value in relation to a charge loss value for a reference temperature. The charge loss temperature component 113 can report the normalized charge loss value in place of the measured charge loss value, and the normalized charge loss value can be used to perform memory operations on the memory device 130. In some embodiments, BFEA is implemented in the memory device 130 and the memory operation is a media scan operation to determine a bin assignment for a particular block family (e.g., based on a determined charge loss value associated with the block family). Further details regarding the operations of the charge loss temperature component 113 will be described below with reference to FIGS. 4A-6.

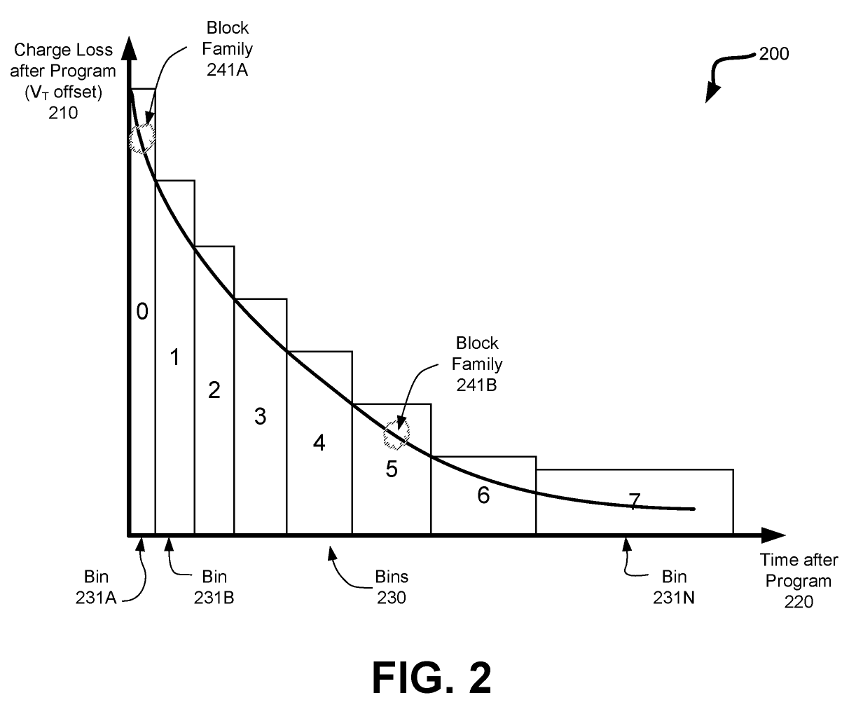

FIG. 2 depicts an example graph 200, illustrating the dependency of charge loss after program (V_{T} offset) 210 on the time after program 220 (i.e., the period of time elapsed since the block has been programmed), according to with some aspects of the disclosure. Graph 200 can be subdivided into multiple bins 230 (shown as bin 231A, bin 231B, and bin 231N) corresponding to time after program 220. Each bin (e.g., bin 231A, etc.) corresponds to a predetermined range of threshold voltage offsets 210. While the illustrative example of FIG. 2 defines 8 bins, in other embodiments, other numbers of bins can be defined (e.g., 4 bins, 64 bins, etc.).

Blocks of the memory device are grouped into block families, such as block family 241A and block family 241B. A block family can include one or more blocks that have been programmed within a specified time window and/or a specified temperature window. As noted herein above, since the time elapsed after programming and temperature are the main factors affecting the TVS (e.g., the voltage shift), blocks and/or partitions within a single block family (such as block family 241A or block family 241B) are presumed to exhibit similar distributions of threshold voltages in memory cells, and thus would require the same voltage offsets for read operations.

Block families can be created asynchronously with respect to block programming events. Over time and/or with changes in temperature, the V_{T} distribution of block family 241A can move closer to the V_{T} distribution of block family 241B currently shown in TAP bin 5. For example, the memory subsystem controller (such as memory sub-system controller 115 as described with respect to FIG. 1) can create a new block family whenever a specified period of time (e.g., a predetermined number of minutes) has elapsed since creation of the last block family. Additionally, or alternatively, the memory sub-system controller (such as memory sub-system controller 115 as described with respect to FIG. 1) can create a new block family whenever the reference temperature of memory cells has changed by more than a specified threshold value since creation of the current block family. In some embodiments, the reference temperature of memory cells can be updated at specified time intervals, and/or in response to a triggering event.

A newly created block family, such as block family 241A, can be associated with bin 0. Based on a periodically performed calibration process, the memory sub-system controller (such as memory sub-system controller 115 as described with respect to FIG. 1) associates each block family (e.g., such as block family 241A, or block family 241B) with a TAP bin (e.g., a voltage offset bin). A TAP bin defines a set of voltage offsets to be applied to the base voltage read level in order to perform read operations, as described in more detail herein below. The associations of blocks with block families, as well as the associations of block families with Bins, can be stored in respective metadata tables maintained by the memory sub-system controller. In some embodiments, the associations of blocks with block families and/or the associations of block families with Bins can be stored in one or more BFEA tables.

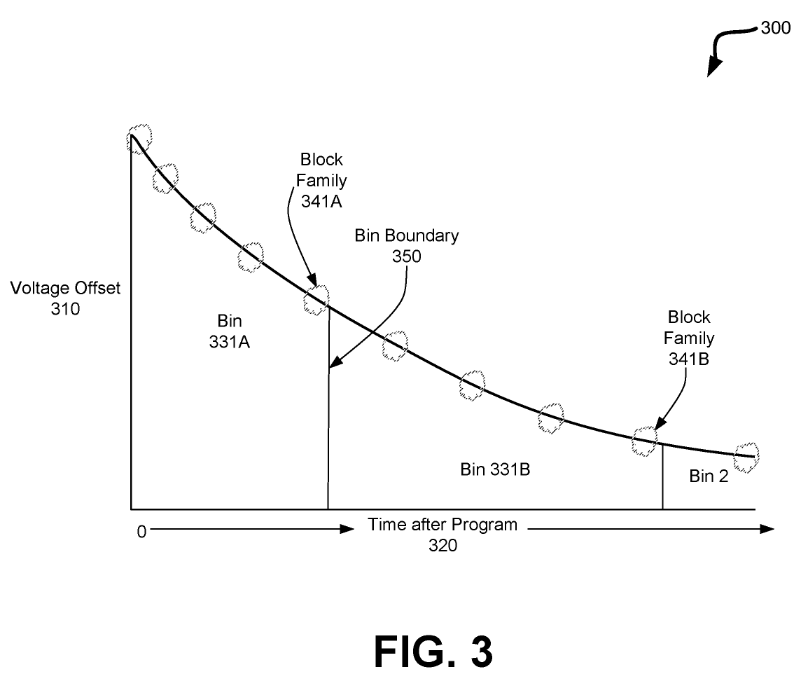

FIG. 3 schematically illustrates block family calibration selection 300, according to some aspects of the disclosure. The memory sub-system controller (such as memory sub-system controller 115 as described with respect to FIG. 1) can perform the calibration operations on one of the oldest block families in each bin (e.g., the block family having the longest time after program 320 value, and thus the lowest voltage offset 310 value of the bin). As illustratively exemplified, the memory sub-system controller can perform calibration operations on block family 341A in bin 331A and block family 341B in bin 331B, since each are the oldest block family that will, due to slow charge loss, migrate across bin boundary 350 (e.g., a predetermined bin voltage boundary) to the next bin before any other block family of each current respective bins.

FIGS. 4A-4B are diagrams of V_{T} distributions illustrating an example implementation of adaptive block family error avoidance (BFEA) in a memory sub-system, according to some aspects of the disclosure. For example, FIG. 4A illustrates a diagram 400A of a left V_{T} distribution 410L and a right V_{T} distribution 410R at a first time. For example, the first time can be the time of programming (e.g., time 0). A center read level 420 can exist in the valley between the V_{T} distributions 410L and 410R. The valley defines a read window. A boundary 430 L can be identified for the left V_{T} distribution 410L and a boundary 430R-1 can be identified for the right V_{T} distribution 410R. The distance between the center read level 420 and the boundary 430L defines a left portion of the read window 440L. The boundaries 440L-1 and 440R-1 can each be identified from a threshold bit error rate (e.g., RBER). The boundaries 440L-1 and 440R-1 can be identified empirically by analyzing charge loss after memory device manufacture. A distance between the center read level 420 and the boundary 440R-1 defines a right portion of the read window 440R-1.

FIG. 4B illustrates a diagram 400B of the left V_{T} distribution 410L and the right V_{T} distribution 410R at a second time after the first time. Due to charge loss that occurred between the first time and the second time, at least the right V_{T} distribution 410R shifted to the left. If the boundary 430R-1 from FIG. 4A remains at the same position, this would result in a bit error rate that exceeds the threshold bit error rate. Thus, to address the shift of the right V_{T} distribution 410R caused by the charge loss, the boundary 430R-1 is updated to boundary 430R-2, which results in an updated distance between the center read level 420 and the boundary 430R-2 defining a right portion of the read window 440R-2. The updated distance is smaller than the previous distance, and thus the right portion of the read window 440R-2 is smaller than the right portion of the read window 440R-1. Moreover, the read window itself has been reduced due to the shift of the right V_{T} distribution 410R.

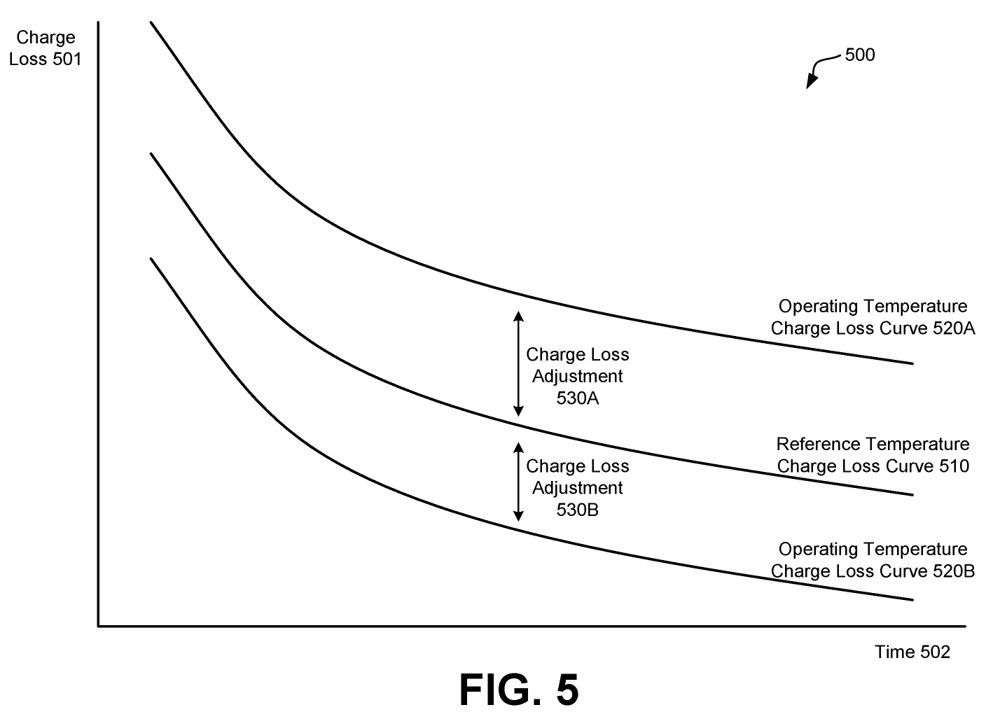

FIG. 5 illustrates a plot 500 of charge loss 501 against time 502 in a memory device, according to some aspects of the disclosure. Reference temperature charge loss curve 510 represents a charge loss curve based on a selected reference temperature for the memory device.

Operating temperature charge loss curve 520A represents a charge loss curve for an operating temperature of the memory device that is above the reference temperature. Operating temperature charge loss curve 520B represents a charge loss curve for an operating temperature of the memory device that is below the reference temperature.

Charge loss adjustment value 530A represents a difference between the operating temperature charge loss curve 520A and the reference temperature charge loss curve 510. In some embodiments, the charge loss adjustment 530A is a constant value. For example, the charge loss adjustment value 530A can represent a vertical shift (e.g., y-axis translation) of the reference temperature charge loss curve 510.

Charge loss adjustment value 530B represents a difference between the operating temperature charge loss curve 520B and the reference temperature charge loss curve 510. In some embodiments, the charge loss adjustment 530B is a constant value. For example, the charge loss adjustment value 530B can represent a vertical shift (e.g., y-axis translation) of the reference temperature charge loss curve 510.

As can be appreciated in the illustrative FIG. 5, the various charge loss curves (e.g., reference temperature charge loss curve 510, operating temperature charge loss curve 520A, and operating temperature charge loss curve 520B) have the same or similar paths, albeit with different vertical shifts (e.g., y-axis translations).

In some embodiments, the plot 500 or a similar plot can be generated for a memory device during production of the memory device. Various operating temperature paths may be plotted to determine respective charge loss adjustment values (e.g., charge loss adjustment 530A or charge loss adjustment 530B). During operation of the memory device, these charge loss adjustment values can be retrieved from a table of stored values (e.g., characterized temperature values). Alternatively, during operation of the memory device, an algorithm based on the generated plot (e.g., plot 500) can be used to determine charge loss adjustment values.

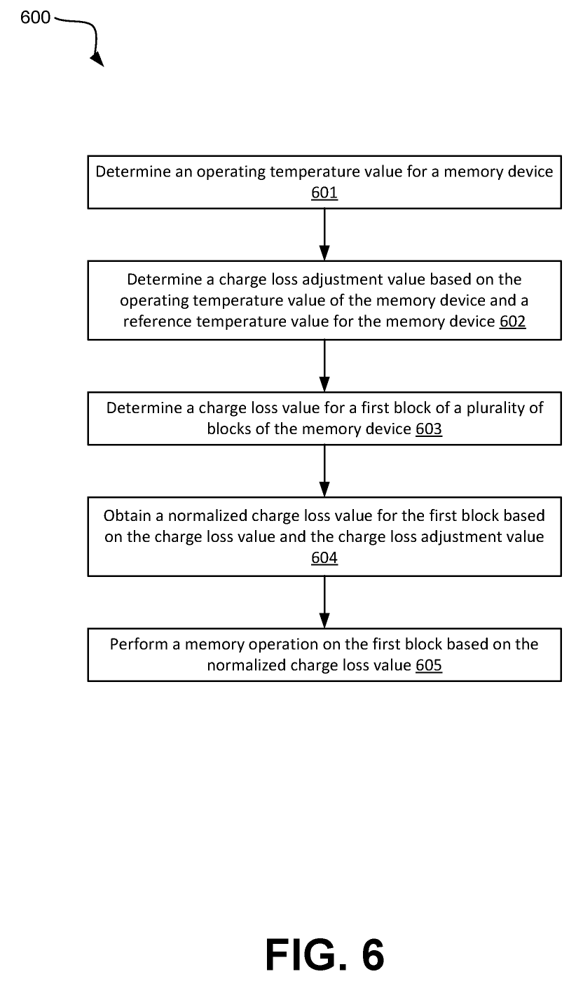

FIG. 6 is a flow diagram of an example method 600 to implement charge loss temperature compensation in a memory sub-system, according to some aspects of the disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the charge loss temperature component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 601, the processing logic performing the method 600 determines an operating temperature value for a memory device. In some embodiments, the operating temperature value can be a current temperature value of the memory device (e.g., obtained from a temperature probe or the like).

In some embodiments, the operation 601 further includes determining whether a difference between an initial temperature of the memory device (e.g., a temperature of the memory device when a previous memory operation was performed) and the operating temperature of the memory device satisfies a temperature change threshold condition. For example, and in some embodiments, the processing logic determines, based on the initial temperature value associated with the first block and the operating temperature value, a temperature change value associated with the first block. The processing logic determines whether the temperature change value satisfies the temperature change threshold condition. In some embodiments, the temperature change value satisfies the temperature change threshold condition if the temperature change value is less than a value representing the temperature change threshold condition. Responsive to determining that the temperature change value does not satisfy the temperature change threshold condition, the processing logic proceeds to operation 602 (below) to determine a charge loss adjustment value.

At operation 602, the processing logic determines a charge loss adjustment value based on the operating temperature value of the memory device and a reference temperature value for the memory device. The reference temperature value for the memory device can be a reference temperature that is selected during production of the memory device. In some embodiments, the reference temperature value is selected based on one or more metrics for performing memory operations at the memory device including, for example, an estimated average memory device temperature for performing memory operations, an estimated median memory device temperature for performing memory operations, or the like. In some embodiments, the reference temperature value is selected based on one or more physical characteristics of the memory device including, for example, a stability of the memory device at a particular temperature, a predictability of the memory device at a particular temperature, maximum-rated operating temperatures of the memory device, or the like.

At operation 603, the processing logic determines a charge loss value for a first block of a plurality of blocks of the memory device. In some embodiments, the charge loss value is determined based on a table of pre-characterized values, as described above with reference to FIG. 5. For example, and with reference to FIG. 5, for a given operating temperature (e.g., associated with the operating temperature charge loss curve 520A), there is a particular charge loss adjustment value (e.g., charge loss adjustment 530A). In some embodiments, the charge loss adjustment value changes over time (e.g., time 502). That is, in some embodiments, the charge loss adjustment 530A can change with respect to time 502. In some embodiments, the charge loss value is determined based on an algorithm derived from pre-characterized plots of charge loss curves for various temperatures with respect to a charge loss curve for a reference temperature (e.g., similar to the plot 500 of FIG. 5). That is, in some alternative embodiments, the charge loss may be determined based on an algorithm instead of a table of pre-determined values.

At operation 604, the processing logic determines a normalized charge loss value for the first block based on the charge loss value and the charge loss adjustment value. In some embodiments, the charge loss value and the charge loss adjustment value are summed together to obtain the normalized charge loss value. In some embodiments, the processing logic determines a modification value for the charge normalized charge loss value. The modification value can be determined based on a difference between an initial temperature of the memory device (e.g., a temperature of the memory device when a previous memory operation was performed) and (i) the operating temperature of the memory device, or (ii) the reference temperature for the memory device. The processing logic can obtain a modified charge loss value based on the normalized charge loss value and the modification value. In some embodiments, the normalized charge loss value and the modification value are summed to obtain the modified charge loss value.

At operation 605, the processing logic performs a memory operation on the first block based on the normalized charge loss value. In some embodiments, the memory operation can be one or more of a read operation, a write operation, an erase operation, an error correction operation, a memory device management operation, or the like.

In some embodiments, the memory operation is a block family error avoidance (BFEA) operation, described above with reference to FIG. 2 and FIG. 3. The processing logic can determine whether the normalized charge loss value satisfies a first threshold condition (e.g., a charge loss threshold associated with an initial bin). The first threshold condition can represent a value of charge loss for a representative block of a block family (here the first block) that, if exceeded, triggers the processing logic to reassign the block family to a new bin. Responsive to determining the normalized charge loss value satisfies the first threshold condition, the processing logic can reassign the first block family from the first bin (e.g., the initial bin) associated with the memory device to a second bin (e.g., the new bin). Each bin associated with the memory device can define a respective grouping of block families based on respective charge loss values.

In some embodiments, once the first block family has been reassigned to the new bin, the processing logic can perform, or cause to be performed, a second memory operation based on the normalized charge loss value. The second memory operation can be performed at a second block of the first block family. In some embodiments, the second memory operation is a read operation.

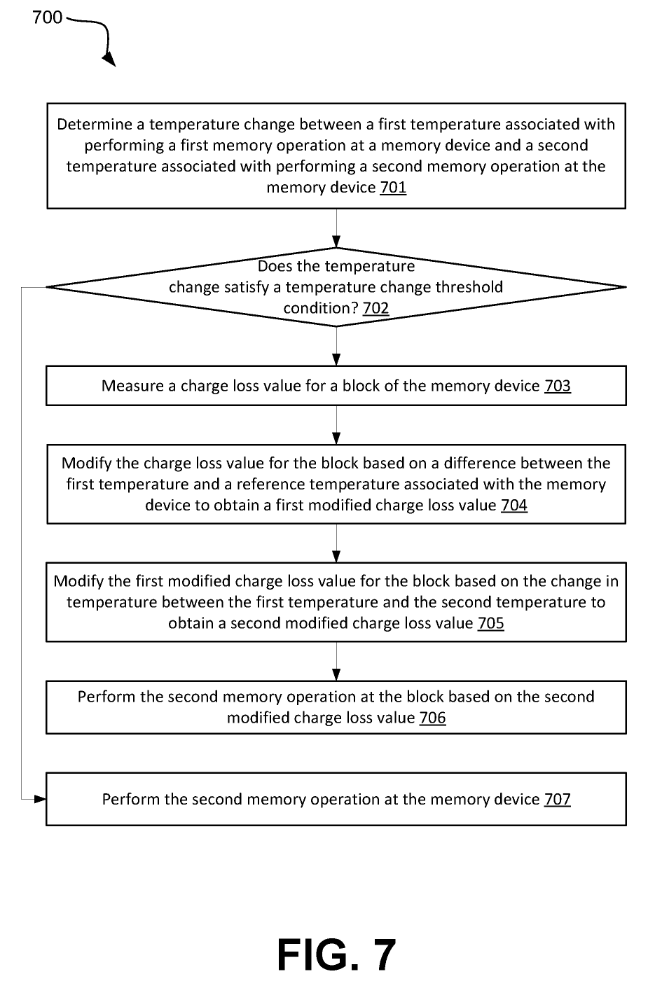

FIG. 7 is a flow diagram of an example method 700 to implement charge loss temperature compensation in a memory sub-system, according to some aspects of the disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the charge loss temperature component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 701, the processing logic performing the method 700 determines a temperature change between a first temperature associated with performing a first memory operation at a memory device and a second temperature associated with performing a second memory operation at the memory device.

At operation 702, the processing logic determines whether the temperature change satisfies a temperature change threshold condition.

At operation 703, responsive to determining that the temperature change does not satisfy the temperature change threshold condition, the processing logic measures a charge loss value for a block of the memory device.

At operation 704, the processing logic modifies the charge loss value for the block based on a difference between the first temperature and a reference temperature associated with the memory device to obtain a first modified charge loss value.

At operation 705, the processing logic modifies the charge loss value for the block based on the change in temperature between the first temperature and the second temperature to obtain a second modified charge loss value.

At operation 706, the processing logic performs the second memory operation at the block based on the second modified charge loss value.

At operation 707, responsive to determining that the temperature change satisfies the temperature change threshold condition, the processing logic performs the second memory operation at the memory device.

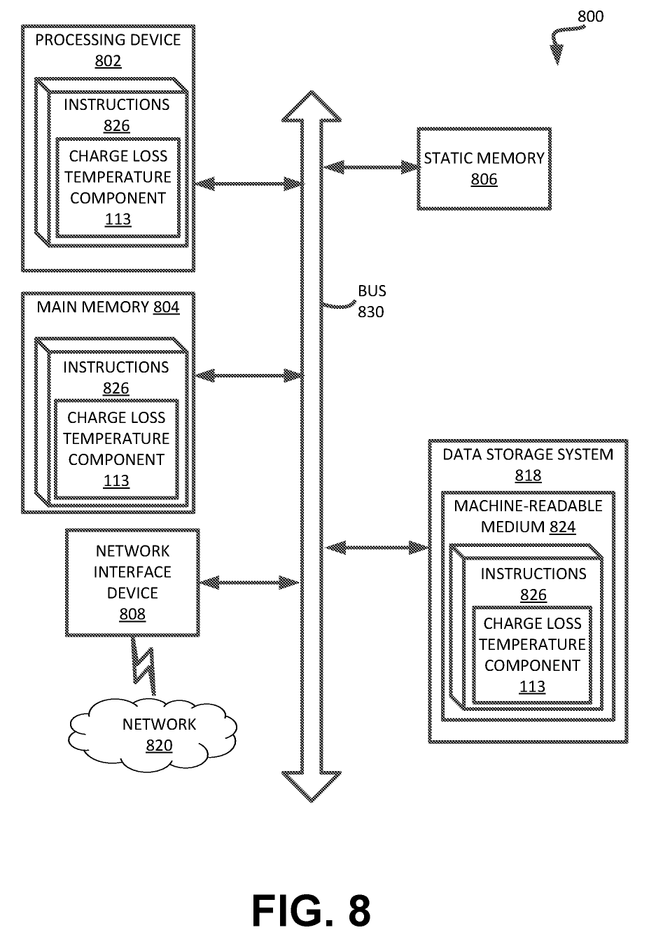

FIG. 8 illustrates an example of a computer system 800 within which a set of instructions, for causing the machine to perform any one or more of the methodologies discussed herein, can be executed, in accordance with aspects of the disclosure. In some embodiments, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the memory operation metadata component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

In some embodiments, computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable non-transitory storage medium) on which is stored one or more sets of instructions 826 or software embodying any one or more of the methodologies or functions described herein. In some embodiments, the data storage system 818 can include a computer-readable non-transitory storage medium, and can be operatively coupled to the processing device 802. The instructions 826 can also reside, completely or at least partially, within the main memory 804 and/or within the processing device 802 during execution thereof by the computer system 800, the main memory 804 and the processing device 802 also constituting machine-readable storage media. In some embodiments, the instructions 826 can be refer to executable instructions. The machine-readable storage medium 824, data storage system 818, and/or main memory 804 can correspond to the memory sub-system 110 of FIG. 1.

In some embodiments, the instructions 826 include instructions to implement functionality corresponding to the memory operation metadata component 113 of FIG. 1). While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a memory device; and
one or more processing devices operatively coupled to the memory device, the one or more processing devices to perform operations comprising:
determining an operating temperature value for the memory device;
determining a charge loss adjustment value based on the operating temperature value of the memory device and a reference temperature value for the memory device;
determining a charge loss value for a first block of a plurality of blocks of the memory device;
obtaining a normalized charge loss value for the first block based on the charge loss value and the charge loss adjustment value; and
performing a first memory operation on the first block based on the normalized charge loss value.

2. The memory sub-system of claim 1, the operations further comprising:
determining, based on an initial temperature value associated with the first block and the operating temperature value, a modification value;
obtaining a modified charge loss value for the first block based on the normalized charge loss value and the modification value; and
performing the first memory operation on the first block based on the modified charge loss value.

3. The memory sub-system of claim 1, the operations further comprising:
determining, based on an initial temperature value associated with the first block and the reference temperature value, a modification value;
obtaining a modified charge loss value for the first block based on the normalized charge loss value and the modification value; and
performing the first memory operation on the first block based on the modified charge loss value.

4. The memory sub-system of claim 1, the operations further comprising:
determining, based on an initial temperature value associated with the first block and the operating temperature value, a temperature change value associated with the first block;
determining whether the temperature change value satisfies a temperature change threshold condition; and
responsive to determining that the temperature change value does not satisfy the temperature change threshold condition, determining the charge loss adjustment value.

5. The memory sub-system of claim 1, wherein the charge loss adjustment value is further determined based on a table comprising a plurality of characterized temperature values associated with respective charge loss values, and wherein values of the table are determined during a production of the memory device.

6. The memory sub-system of claim 1, wherein the first block is a representative block for a first block family of a plurality of block families, and wherein performing the first memory operation on the first block comprises:
determining whether the normalized charge loss value satisfies a first threshold condition; and
responsive to determining the normalized charge loss value satisfies the first threshold condition, reassigning the first block family from a first bin of a plurality of bins associated with the memory device to a second bin of the plurality of bins, wherein each bin of the plurality of bins defines a respective grouping of block families based on respective charge loss values.

7. The memory sub-system of claim 6, the operations further comprising:
performing a second memory operation based on the normalized charge loss value, wherein the second memory operation comprises a read operation at a second block of the first block family.

8. A method comprising:
determining, by one or more processing devices, an operating temperature value for a memory device;
determining a charge loss adjustment value based on the operating temperature value of the memory device and a reference temperature value for the memory device;
determining a charge loss value for a first block of a plurality of blocks of the memory device;
obtaining a normalized charge loss value for the first block based on the charge loss value and the charge loss adjustment value; and
performing a first memory operation on the first block based on the normalized charge loss value.

9. The method of claim 8, the method further comprising:
determining, based on an initial temperature value associated with the first block and the operating temperature value, a modification value;
obtaining a modified charge loss value for the first block based on the normalized charge loss value and the modification value; and
performing the first memory operation on the first block based on the modified charge loss value.

10. The method of claim 8, the method further comprising:
determining, based on an initial temperature value associated with the first block and the reference temperature value, a modification value;
obtaining a modified charge loss value for the first block based on the normalized charge loss value and the modification value; and
performing the first memory operation on the first block based on the modified charge loss value.

11. The method of claim 8, the method further comprising:
determining, based on an initial temperature value associated with the first block and the operating temperature value, a temperature change value associated with the first block;
determining whether the temperature change value satisfies a temperature change threshold condition; and
responsive to determining that the temperature change value does not satisfy the temperature change threshold condition, determining the charge loss adjustment value.

12. The method of claim 8, wherein the charge loss adjustment value is further determined based on a table comprising a plurality of characterized temperature values associated with respective charge loss values, and wherein values of the table are determined during a production of the memory device.

13. The method of claim 8, wherein the first block is a representative block for a first block family of a plurality of block families, and wherein performing the first memory operation on the first block comprises:
determining whether the normalized charge loss value satisfies a first threshold condition; and
responsive to determining the normalized charge loss value satisfies the first threshold condition, reassigning the first block family from a first bin of a plurality of bins associated with the memory device to a second bin of the plurality of bins, wherein each bin of the plurality of bins defines a respective grouping of block families based on respective charge loss values.

14. The method of claim 13, the method further comprising:
performing a second memory operation based on the normalized charge loss value, wherein the second memory operation comprises a read operation at a second block of the first block family.

15. A computer-readable non-transitory storage medium comprising instructions, that when read, cause one or more processing devices to perform operations comprising:
determining, by one or more processing devices, an operating temperature value for a memory device;
determining a charge loss adjustment value based on the operating temperature value of the memory device and a reference temperature value for the memory device;
determining a charge loss value for a first block of a plurality of blocks of the memory device;
obtaining a normalized charge loss value for the first block based on the charge loss value and the charge loss adjustment value; and
performing a first memory operation on the first block based on the normalized charge loss value.

16. The computer-readable non-transitory storage medium of claim 15, the operations further comprising:
determining, based on an initial temperature value associated with the first block and the operating temperature value, a modification value;
obtaining a modified charge loss value for the first block based on the normalized charge loss value and the modification value; and
performing the first memory operation on the first block based on the modified charge loss value.

17. The computer-readable non-transitory storage medium of claim 15, the operations further comprising:
determining, based on an initial temperature value associated with the first block and the reference temperature value, a modification value;
obtaining a modified charge loss value for the first block based on the normalized charge loss value and the modification value; and
performing the first memory operation on the first block based on the modified charge loss value.

18. The computer-readable non-transitory storage medium of claim 15, the operations further comprising:
determining, based on an initial temperature value associated with the first block and the operating temperature value, a temperature change value associated with the first block;
determining whether the temperature change value satisfies a temperature change threshold condition; and
responsive to determining that the temperature change value does not satisfy the temperature change threshold condition, determining the charge loss adjustment value.

19. The computer-readable non-transitory storage medium of claim 15, wherein the charge loss adjustment value is further determined based on a table comprising a plurality of characterized temperature values associated with respective charge loss values, and wherein values of the table are determined during a production of the memory device.

20. The computer-readable non-transitory storage medium of claim 15, wherein the first block is a representative block for a first block family of a plurality of block families, and wherein performing the first memory operation on the first block comprises:
determining whether the normalized charge loss value satisfies a first threshold condition; and
responsive to determining the normalized charge loss value satisfies the first threshold condition, reassigning the first block family from a first bin of a plurality of bins associated with the memory device to a second bin of the plurality of bins, wherein each bin of the plurality of bins defines a respective grouping of block families based on respective charge loss values.
